(19) United States
(12) Patent Application Publication
(10) Pub. No.: US 2011/0045334 A1
(43) Pub. Date: Feb. 24, 2011

(54) Battery with a Case and a Heat-Conducting Plate

(76) Inventors: Jens Meintschel, Bernsdorf (DE); Dirk Schroeter, Winnenden (DE)

Correspondence Address: CROWELL & MORING LLP;INTELLECTUAL PROPERTY GROUP, P.O. BOX 14300, WASHINGTON, DC, 20044-4300, US

(21) Appl. No.: 12/809,506

(22) PCT Filed: Nov. 21, 2008
(86) PCT No.: PCT/EP08/09851

§ 371 Date: Oct. 21, 2010

(30) Foreign Application Priority Data
Dec. 20, 2007 (DE) 10 2007 063 195.4

(51) Int. Cl. H01M 10/50

(52) U.S. Cl. 429/120

(57) ABSTRACT

A battery with a case and a heat-conducting plate for adjusting the temperature of the battery has several individual cells that are connected in parallel or in series, and are thermally coupled to the heat-conducting plate. The battery is formed of at least two cell stacks that are arranged one after the other. The heat-conducting plate (8) is arranged between the cell stacks, so that the effective heat-conducting cross section of the heat-conducting plate is utilized on both sides.

This application is a national stage of PCT International Application No. PCT/EP2008/009851, filed Nov. 21, 2008, which claims priority under 35 U.S.C. §119 to German Patent Application No. 10 2007 063 195.4, filed Dec. 20, 2007, the entire disclosure of which is herein expressly incorporated by reference.

The invention relates to a battery with a case and a heat-conducting plate, wherein the battery has several individual cells connected in particular in parallel and/or in series, which are combined to a cell stack.

German patent document DE 698 23 745 T2 discloses a battery with a case, in whose interior are arranged several individual cells. The individual cells are respectively provided with a pole on the end side in the longitudinal direction. Several individual cells are combined to a cell stack. The poles of abutting individual cells of two adjacent cell stacks are arranged in bores of a heat-conducting plate. The individual cells arranged at a face side of a cell stack have a direct heat-conducting contact with the heat-conducting plate. The remaining individual cells, also those arranged at the other face side, are connected by means of heat-conducting bars in an indirect heat-conducting manner, wherein the heat-conducting bars support all individual cells arranged one faster the other on the longitudinal side.

In German patent document DE 698 25 067 T2 a battery has individual cells which are formed in a prismatic manner. The individual cells are combined to cell stacks. Heat-conducting plates are arranged at flat sides of the cell stack where no electrical poles are arranged.

Previously unpublished German patent document DE 102007010739.2-45 discloses a battery with a case and a heat-conducting plate for adjusting the temperature of the battery. The battery can be used as a vehicle battery, for example in a vehicle with a hybrid drive and/or in a vehicle operated with fuel cells. The battery thereby has several individual cells connected in parallel or in series, which are arranged parallel to each other with the longitudinal axes and which form a cell stack. The individual cells are connected in a heat-conducting manner to the heat-conducting plate at the top or face side for a heat discharge. The individual cells are furthermore provided with a casing for a heat discharge, for example of aluminum, which is connected to the heat-conducting plate. A channel structure is connected within the heat-conducting plate for an efficient heat deflection, which structure is flown through by a heat-conducting medium, which can be supplied or discharged via connection points. The heat resulting in the individual cells during the charging and discharging of the battery, especially lithium ion battery cells, which have a maximum permissible temperature of 50° C., can for example be discharged into an air-conditioning circuit of an air-conditioning system in a vehicle via the channel structure of the heat-conducting plate.

One object of the invention is to provide a battery for vehicles with a hybrid drive, which is cost-efficient and simple.

This and other objects and advantages are achieved by the battery according to the invention (also called a “cell block”) with a case and a heat-conducting plate for adjusting the temperature of the battery, which battery has several individual cells (for example lithium ion battery cells) which are connected to the heat-conducting plate in a heat-conducting manner. The battery thereby comprises at least two cell stacks arranged one after the other in the longitudinal direction, in which are arranged several individual cells connected in parallel and/or in series. For a design of the battery which is optimized with regard to the installation space, a single heat-conducting plate is arranged instead of two heat-conducting plates arranged at the face or top side, which discharges the heat from individual cells of two cell stacks. A heat transfer is thus possible on both sides of the heat-conducting plate.

The individual cells are preferably respectively provided with a pole in the longitudinal extension at the end side, that is, at the top and bottom side. By means of this formation of poles opposite each other of each individual cell and the heat-conducting plate arranged between respectively two cell stacks and thus between two individual cells arranged one after the other, the battery can be extended by further cell stacks on the top and/or bottom side depending on demand.

For an efficient heat discharge from the individual cells of the respective cell stacks, the heat-conducting plate is arranged between them. The individual cells of an individual cell stack are thereby arranged next to each other parallel with the longitudinal axes and are respectively connected to the heat-conducting plate in a heat-conducting manner. The individual cells of adjacent cell stacks abutting each other are arranged opposite each other one after the other in the longitudinal extension and with intermediate arrangement of the heat-conducting plate.

In a possible embodiment, the poles of the opposite individual cells of adjacent cell stacks project into bores of the heat-conducting plate and are connected there in an electrical manner. This can thereby in particular be a through-bore. The poles of abutting individual cells of two cell stacks are thus opposite each other optimizing the installation space. In a possible arrangement of the invention, the poles preferably each have an outer thread, by which the respective individual cell can be fastened in one of the bores of the heat-conducting plate.

By the outer threads formed at the poles and the corresponding counter pieces arranged in the bores, in particular threaded sleeves with inner thread or inner threads in the bores, the individual cells are connected to each other electrically and can be fixed in the heat-conducting plate. The battery can be built into a battery case in an advantageous manner, for example in a lying position, by the two-sided arrangement at the heat-conducting plate and the form-fit and force-fit fastening of the individual cells of two cell stacks.

The battery according to the invention, in particular a vehicle battery, can preferably be used in a vehicle with hybrid drive and/or in a vehicle operated with fuel cells, in particular in a vehicle for carrying passengers.

In order to ensure an electrical insulation between the heat-conducting plate and the cell stacks, an insulation ring is respectively preferably placed on the poles of the individual cells contacting through the bores of the heat-conducting plate. The insulation ring preferably adjusts a heat-conducting gap between the individual cell and the heat-conducting plate that can be predetermined. The insulation rings are conveniently formed of plastics in a possible embodiment.

For ensuring the electrical insulation of the components arranged individually in the battery case, such as individual cells, heat-conducting bars, an electrically insulating and preferably heat-conducting casting mass and/or an electrically insulating and preferably heat-conducting foam is arranged in the intermediate spaces of heat-conducting plate and individual cells of the cell stacks, that is, in heat-conducting bars in a further arrangement of the invention. The casting mass and/or the foam thereby completely fill the hollow spaces of the battery case. The above-mentioned intermediate spaces within the battery case are hereby efficiently used for the heat deflection and electrical insulation, wherein the stability of the entire battery case is simultaneously increased.

In a possible embodiment of the battery according to the invention, the individual cells respectively have a casing for the heat deflection. The casing is preferably formed of aluminum and can have a wall thickness formed in an irregular manner, whereby the heat can be discharged in the longitudinal direction of the individual cells. The wall thickness can for example increase or decrease in the longitudinal extension of the individual cell.

Additionally, heat-conducting bars, preferably of aluminum, can be arranged in a further arrangement of the battery according to the invention in the intermediate spaces of the individual cells of the respective cell stack for an efficient heat deflection from the individual cells, which have a permissible maximum temperature of 50°. By a for example hexagonal arrangement of the heat-conducting bars around the respective individual cell, the heat which is generated especially during charging is discharged from the individual cells around their circumference to the heat-conducting plate in a homogeneous manner.

In order to be able to discharge the supplied heat amongst others via the casting mass and/or the foam and/or the heat-conducting bars in an efficient manner, a channel structure with connection points for a heat-conducting medium is arranged therein. The heat-conducting medium, which flows through the channel structure, serves for a removal of the heat generated by the cell stacks, for example via an air-conditioning circuit of a vehicle connected via the connection points.

The battery or the cell block with the cell stacks wired by the individual cells is furthermore surrounded by a battery case. In a particularly advantageous arrangement of the battery according to the invention, the battery case has a surface structure to the outside, in particular a groove-shaped surface structure, whereby the battery can be additionally cooled by the case.

Adjacent individual cells within a cell stack are conveniently connected to each other in an electrical manner by means of cell connectors. By means of the heat conducting plate arranged centrally between the cell stacks, the electrical contacting of opposite individual cells of adjacent cell stacks through the heat-conducting plate and the electrical contacting of adjacent individual cells of a cell stack through the electrical cell connectors, the voltage connection can advantageously only take place on one side of the battery, in particular only at one of the cell stacks. An additional voltage bar for the electrical connection of the battery also at the cell stacks is not necessary anymore and can thus be omitted.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic depiction of two individual cells with poles at their end sides connected to each other in the longitudinal extension;

FIG. 2 shows schematically the two connected individual cells according to FIG. 1 in an exploded view;

FIG. 3 shows schematically a battery with cell stacks respectively formed of several individual cells, whose individual cells are connected to each other via an intermediate heat-conducting plate;

FIG. 4 is a further schematic depiction of a battery with individual cells of one of the cell stacks connected electrically via cell connectors;

FIG. 5 shows schematically in perspective a battery with an individual voltage connection for the battery provided at one of the cell stacks;

FIG. 6 is a schematic top or plan view of the battery; and

FIG. 7 is a schematic sectional depiction of the battery according to FIG. 6.

### DETAILED DESCRIPTION OF THE DRAWINGS

Parts corresponding to each other are provided with the same reference numerals in all figures.

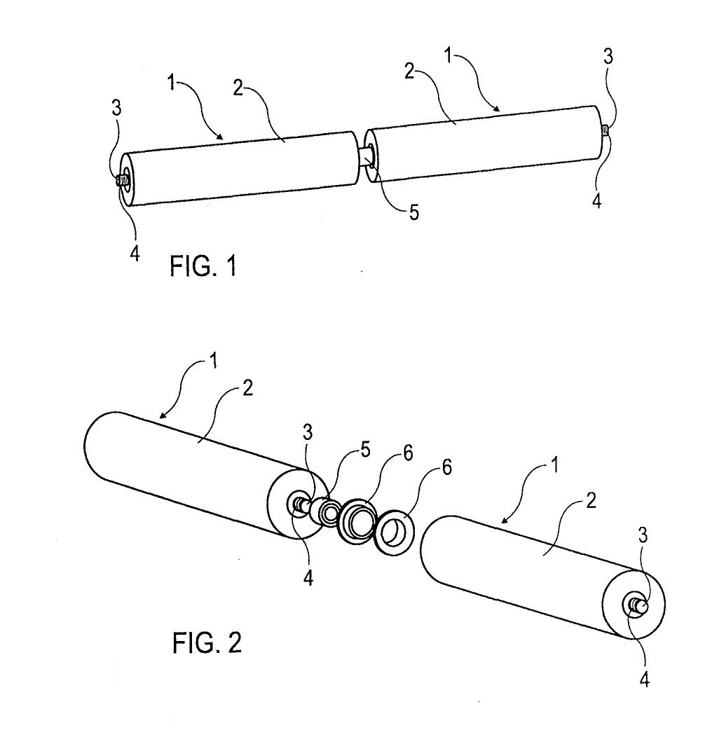

In FIG. 1 are shown two individual cells 1, which are connected to each other in the longitudinal extension. The respective individual cell 1 is surrounded by a casing 2, which is preferably formed as a circular cylinder, and which has an irregular wall thickness, not shown in detail, for heat deflection.

Each individual cell 1 is provided with a pole 3 on its end side. The poles 3 of the shown individual cells 1 have a thread 4, in particular an outer thread. The individual cells 1 are connected electrically via the threads 4 formed at the poles 3 and a corresponding threaded sleeve 5.

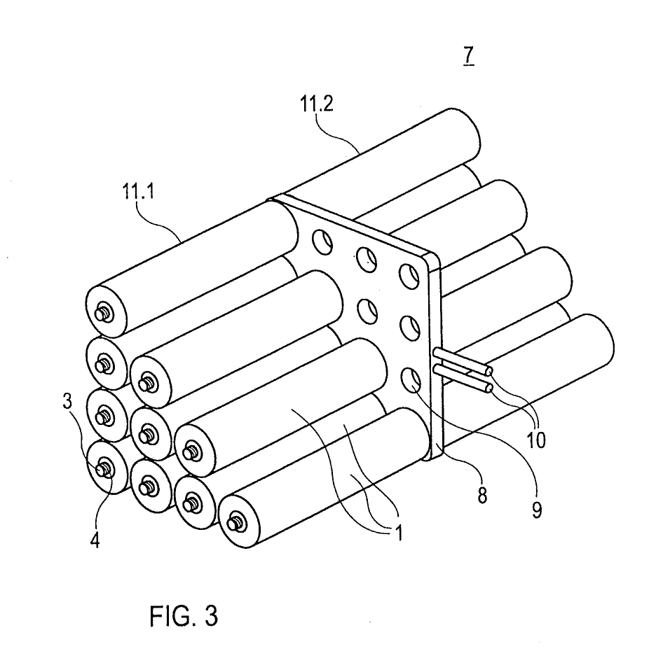

FIG. 2 shows the detailed depiction of the electrical connection of the two individual cells 1 according to FIG. 1 in an exploded view. The two individual cells are shown with threads 4 formed at their poles 3. An insulation ring 6 can respectively placed onto the poles 3 directly opposing each other in the longitudinal direction for the electrical insulation of the poles 3 with regard to other battery components. The diameter of the insulation ring 6 is predefined in such a manner that the insulation ring 6 can be placed onto the threaded sleeve 5 surrounding the pole 3.

During assembly, the threaded sleeve 5 can be screwed onto one of the poles of the two individual cells 1 arranged with regard to each other. For this, the threaded sleeve 5 has an inner thread, not shown in detail, corresponding to the outer thread 4 of the respective pole 3. Subsequently, the insulation ring or rings 6 is or are placed on the threaded sleeve 5 screwed onto one of the poles 3. In a next step, the second individual cell 1 can then be screwed into the other open end of the threaded sleeve 5 via its pole 3. Depending on the type and design, an individual hollow-cylindrical insulation ring 6 can be provided with opening edges respectively angled or an associated insulation ring 6 per pole, as shown.

FIG. 3 shows a battery 7 (also called cell block) with incomplete cell stacks 11.1, 11.2 arranged one after the other and a heat-conducting plate 8 arranged between these.

The respective cell stack 11.1, 11.2 comprises a plurality of individual cells 1 arranged in parallel adjacent to each other, which are connected to the individual cells 1 of the adjacent cell stack 11.1, 11.2 in an electrical manner by the heat-conducting plate 8 arranged between these in the manner described above (FIGS. 1 and 2).

The heat-conducting plate 8 has bores 9 for this, which are formed as through-bores. The diameter of the bores 9 is thereby chosen in such a manner that it is smaller than the diameter of the respective cell bottom of the individual cell 1 and larger than the outer diameter of the threaded sleeve 5.

The individual cells 6 of one of the two cell stacks 11.1 on one of the sides of the heat-conducting plates 8 are first introduced into the bores 9 with a threaded sleeve 5 which is already screwed onto the respective pole 3 and an insulation ring placed thereon. The individual cells 1 of the other cell stack 11.2 are then subsequently screwed into the threaded sleeve 5 on the other side of the heat-conducting plate 8, until the individual cell 1 is arranged in a fixed manner at the heat-conducting plate 8 by means of the screw connection.

Alternatively, the insulation rings 6 can first be inserted into the bores 9 and be fixed there, for example in a latching manner, into which the threaded sleeves 5 are then inserted and are fixed, e.g., in a latching manner. The respective individual cells 1 are subsequently screwed into the threaded sleeve 5 on both sides of the heat-conducting plate 8 via their poles 3 with the outer thread 4. In this embodiment, additional fixing elements for the insulation rings 6 and the threaded sleeves 5 are necessary.

In the other embodiment, with threaded sleeves 5 which are already screwed onto poles 3 of individual cells 1 of one of the cell stacks 11.1 and fitted insulation rings 6, the individual cells 1 of both abutting cell stacks 11.1, 11.2 are fastened and screwed to the heat-conducting plate 8 by screwing the poles 3 of the individual cells 1 of the other cell stack 11.2.

The individual cells 1 of a respective cell stack 11.1, 11.2 are thus fastened to the heat-conducting plate 3 in a form-fit and force-fit manner, and the individual cells 1 of both cell stacks 11.1, 11.2 are connected to each other in a force-fit and electrical manner. The threaded sleeve 5 is made of an electrically conductive material, in particular of a metal, for an electrical connection of the individual cells 1 of two cell stacks 11.1, 11.2.

The individual cells 1 of the cell stacks arranged one after the other thus contact in an electrical manner and are fastened horizontally on both sides to the heat-conducting plate 8 by means of the formed threads 4 at the poles 3 and the corresponding threaded sleeves 5 inserted into the bores 9 in a form-fit and force-fit manner.

The heat-conducting plate 8 furthermore has connection points 10 for supplying and discharging a heat-conducting medium flowing through the heat-conducting plate 8, in particular a coolant, e.g., air or a liquid coolant.

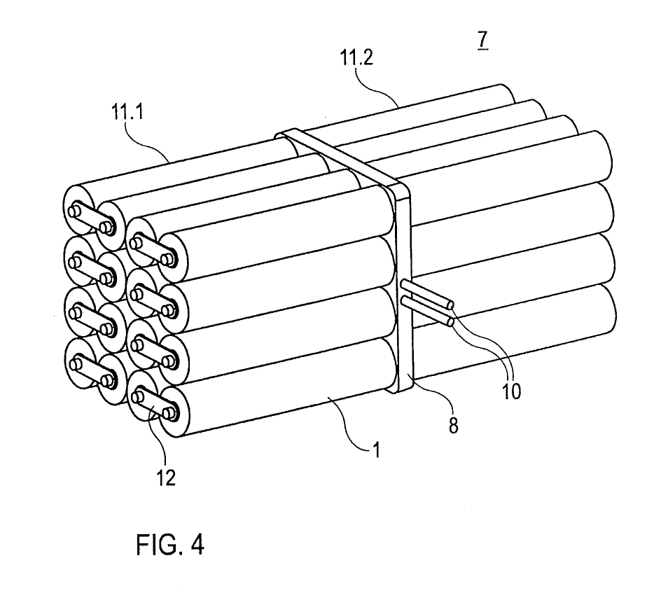

FIG. 4 shows a top- or bottom-side depiction of a battery 7 with the heat-conducting plate 8 arranged centrally between the cell stacks 11.1, 11.2 arranged behind one another.

The poles 3 of the individual cells 1 of the respective cell stacks 11.1, 11.2 arranged at the heat-conducting plate 8 are connected via cell connectors at their free end. The poles 3 of adjacent individual cells 1 of an individual cell stack 11.1, 11.2 are connected to each other in an electrical manner by means of the cell connectors 12, for example wired in parallel or in series.

The respective cell stack 11.1, 11.2 has for example an arrangement of four by four individual cells 1.

In FIG. 5 is shown the opposite side of the battery 7 according to FIG. 4.

The individual cells 1 of the cell stack 11.1, 11.2 are here also connected to each other in an electrical manner via the cell connectors 12. Depending on the use of the battery 7, the individual cells 1 of the respective cell stacks 11.1, 11.2 can be wired in parallel and/or in series.

The battery 7 is provided with a voltage connection 13 at the shown face or head side. The individual cells 1 of both cell stacks 11.1, 11.2 are thereby wired in an electrical manner in such a manner that these are only supplied via this individual voltage connection 13 arranged on one of the sides of the battery 7 (top or bottom side). The voltage path is guided through the entire battery 7 via the electrical connection of all individual cells 1. A laying of additional voltage bars is thereby not necessary.

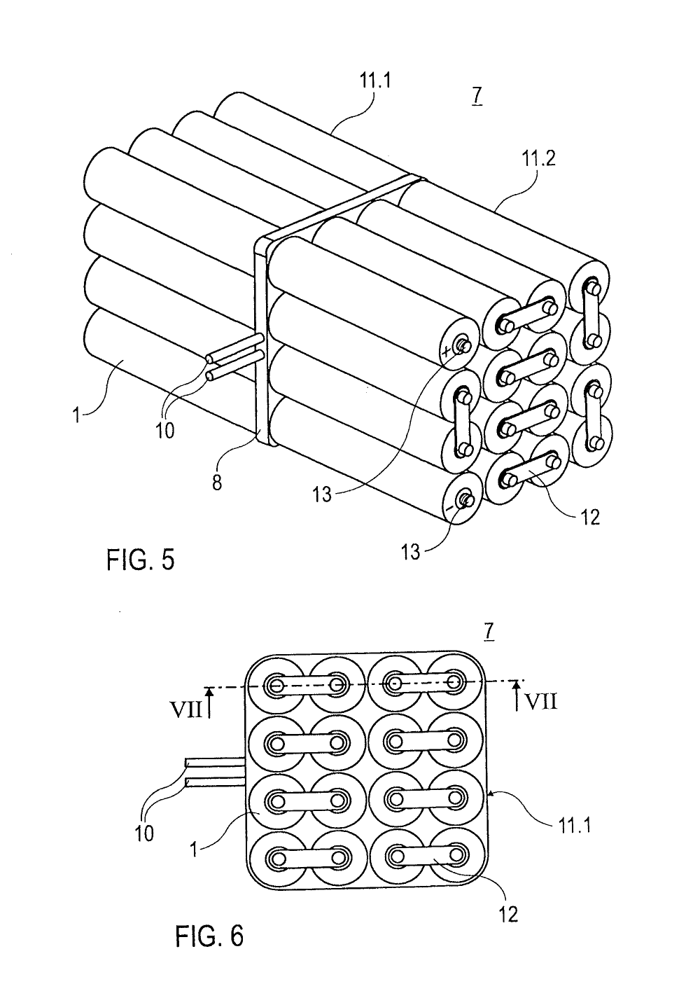

FIG. 6 schematically shows a top view on the rear side of the battery 7 according to the invention shown in FIG. 4 without voltage connection 13 with the electrical cell connector 12, which connects the individual cells 1 to each other in an electrical manner.

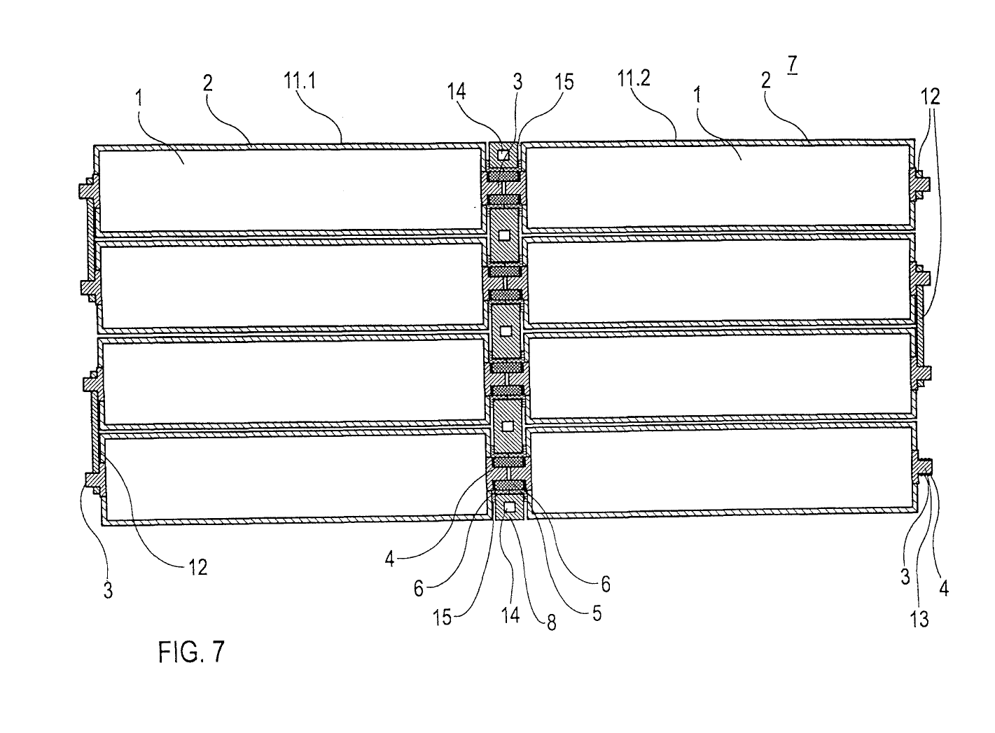

FIG. 7 shows a longitudinal section of the battery 7 with the cell stacks 11.1, 11.2 arranged one after the other and the heat-conducting plate 8 arranged between these according to FIG. 6.

A channel structure 14 for the heat-conducting medium is arranged within the heat conducting plate 8, which medium can be supplied and discharged again via the connection points 10. The heat-conducting medium flows through the channel structure 14 and thereby discharges the heat supplied to the heat-conducting plate 8. The heat supplied to the heat-conducting plate 8 by means of the cell stacks 11.1, 11.2 can thereby be discharged.

The individual cells of the opposite cell stacks 11.1, 11.2 are contacted in an electrical manner to each other by the bores 9 via the threaded sleeve 5 and are fastened to the heat-conducting plate 8 in a form-fit manner. The insulation rings 6 are placed onto the poles 3 of the individual cells 1 arranged in the heat-conducting plate 8 for the electrical insulation between the individual cell 1 and the heat-conducting plate 8. The insulation rings 6 surround the poles 3 and the threaded sleeve 5. By means of the angled opening edge of the insulation rings 6 a heat-conducting gap 15 that can be predetermined is simultaneously adjusted between the heat-conducting plate 8 and the individual cell 1, which can for example be filled during a casting process with electrically insulating and heat-conductive casting mass and/or an electrically insulating and heat-conductive foam.

Furthermore, each hollow space of the battery 7 and each intermediate space between the individual cells 1 and/or the heat-conducting plate 8 and/or the battery case, not shown in detail, can preferably be filled with a heat-conducting casting mass and/or a heat-conducting foam.

The poles 3 of the individual cells 1 arranged at the opposite end to the heat-conducting plate 8 and which are free, are preferably connected to each other in an electrical manner by means of the cell connectors 12.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Individual cells
2 Casing
3 Poles
4 Thread
5 Threaded sleeve
6 Insulation ring
7 Battery
8 Heat-conducting plate
9 Bores
10 Connection points for heat-conducting medium
11 Cell stack
12 Cell connector
13 Voltage connection
14 Channel structure for heat-conducting medium Heat-conducting gap

1.-14. (canceled)

15. A battery having a case, a heat-conducting plate for adjusting the temperature of the battery, and a plurality of individual cells, each of which is provided with a pole in a longitudinal direction on an end thereof, poles abutting individual cells of two adjacent cell stacks being opposite each other and several individual cells being combined to form a cell stack, wherein:
the battery comprises at least two cell stacks arranged one after the other in the longitudinal direction, with individual cells of a cell stack being connected to a heat-conducting plate in a heat-conducting manner;
opposite poles of adjacent cell stacks project into bores of the heat-conducting plate and are electrically connected there;
a heat-conducting plate is respectively arranged between each of the cell stacks arranged one after the other;
each individual cell of a cell stack is connected to a heat-conducting plate in a heat-conducting manner;
the poles have threads;
poles of abutting individual cells, which belong to cell stacks that are arranged one after the other, can be screwed into a threaded sleeve opposite each other; and
individual cells which are electrically connected by the threaded sleeve are also fastened to the heat-conducting plate by the threaded sleeve.

16. The battery according to claim 15, wherein a cell stack comprises a plurality of individual cells that are arranged parallel and adjacent to each other.

17. The battery according to claim 16, wherein individual cells of adjacent cell stacks are connected electrically to each other by the heat-conducting plate.

18. The battery according to claim 17, wherein the individual cells connected electrically to each other by the threaded sleeves are fastened to the heat-conducting plate by the threaded sleeve.

19. The battery according to claim 16, wherein:
each of the poles of the respective individual cells has at least one insulation ring arranged thereon, directed toward the heat-conducting plate.

20. The battery according to claim 19, wherein the insulation rings are formed of plastics.

21. The battery according to claim 15, wherein one of an electrically insulating and heat-conductive casting mass and an electrically insulating and heat-conductive foam, is arranged within the case in intermediate spaces between the heat-conducting plate and individual cells and between the individual cells.

22. The battery according to claim 21, wherein the intermediate space is filled completely by at least one of the casting mass and the foam.

23. The battery according to claim 15, wherein a channel structure is arranged within the heat-conducting plate.

24. The battery according to claim 15, wherein electrical cell connectors are arranged at the free ends of the individual cells.
